(19) United States
(12) Patent Application Publication
(10) Pub. No.: US 2011/0212718 A1
(43) Pub. Date: Sep. 1, 2011

(54) METHODS AND APPARATUS FOR STABILIZING REFERENCE OSCILLATORS

(75) Inventors: Klaus Juergen Schoepf, Chandler, AZ (US); Jan H. Kuypers, Cambridge, MA (US); Reimund Rebel, Maricopa, AZ (US)

(73) Assignee: Sand9, Inc., Cambridge, MA (US)

(21) Appl. No.: 13/036,158

(22) Filed: Feb. 28, 2011

Related U.S. Application Data
(60) Provisional application No. 61/309,339, filed on Mar. 1, 2010.

(51) Int. Cl. G01S 19/46; H04B 7/08; H04W 4/00

(52) U.S. Cl. 455/422.1; 342/357.29; 455/132

(57) ABSTRACT

Apparatus and methods for stabilizing reference oscillators are described. According to some embodiments, the reference oscillator of a device may be stabilized by synchronizing the reference oscillator to an external signal received by the device. The device may be a navigation device in some embodiments, and the external signal may represent or be synchronized to an atomic clock signal or other signal exhibiting sufficient stability.

### RELATED APPLICATIONS

The present application claims the benefit under 35 U.S.C. §119(e) of U.S. Provisional Patent Application Ser. No. 61/309,339, filed on Mar. 1, 2010 under Attorney Docket No. G0766.70016US00 and entitled “METHODS AND APPARATUS FOR STABILIZING REFERENCE OSCILLATORS”, which is incorporated herein by reference in its entirety.

### BACKGROUND

1. Field

The technology described herein relates to methods and apparatus for stabilizing reference oscillators.

2. Related Art

Global Positioning System (GPS) technology is widely used for civil as well as military navigation and position finding. Recently, GPS based position finding has become a ubiquitous consumer technology, appearing in car navigation units and cellular phones.

GPS signal quality and strength, and therefore the performance of GPS receivers, is negatively impacted by multiple factors. Those factors include some weather conditions, attenuation of the GPS signals by buildings and objects, and multi-path signals and multi-path fading encountered in urban environments. Some such factors result in weak GPS signals or GPS signal outages, which cause inaccurate position readings from the GPS receivers. In addition, current GPS receivers require a long time to establish an initial position (referred to as “Time To First Fix” (TTFF)) and subsequent positions (referred to as “Time To Subsequent Fix” (TTSF)), which times are also extended by weak GPS signals and GPS signal outages. This limits the use of GPS in buildings, tunnels, caves and under water.

### SUMMARY

According to one aspect, an apparatus is provided comprising a reference oscillator configured to generate an oscillating reference signal, and a first receiver configured to receive a first wireless signal. The reference oscillator and the first receiver are coupled together and configured to synchronize the oscillating reference signal to the first wireless signal such that a frequency of the oscillating reference is synchronized to a frequency of the first wireless signal. The apparatus further comprises a second receiver configured to receive a second wireless signal different from the first wireless signal, wherein the second receiver is configured to process the second wireless signal using the oscillating reference signal.

According to another aspect, a method is provided comprising receiving a first wireless signal with a device and synchronizing a reference oscillator of the device to the first wireless signal such that a frequency of a oscillating reference signal produced by the reference oscillator is synchronized to a frequency of the first wireless signal. The method further comprises receiving a second wireless signal different from the first wireless signal with the device, and processing the second wireless signal using the oscillating reference signal.

According to another aspect, a method of stabilizing an oscillating reference signal generated by a reference oscillator of a navigation receiver configured to receive a navigation signal is provided. The method comprises receiving an external oscillating carrier signal different from the navigation signal and synchronizing the oscillating reference signal to the external oscillating carrier signal.

According to another aspect, a navigation receiver is provided comprising a reference oscillator configured to generate an internal oscillating reference signal and a global positioning system (GPS) receiver configured to receive a GPS signal and the internal oscillating reference signal and process the GPS signal to determine a GPS location. The navigation receiver further comprises a secondary receiver configured to receive an external oscillating signal different than the GPS signal, wherein the reference oscillator is coupled to the secondary receiver.

Further aspects will be evident from the following detailed description, and it should be appreciated that the various aspects are not limited to use in navigation receivers. Furthermore, the aspects described herein (above and below) may be used individually or in any suitable combination of two or more.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a conventional GPS receiver.

FIG. 2 is a block diagram of a GPS receiver having an oscillator synchronized to an frequency modulation (FM) carrier, according to one embodiment of the present invention.

FIG. 3 illustrates a block diagram of a GPS receiver having an oscillator synchronized to an FM carrier, according to an alternative embodiment of the present invention.

FIG. 4 is a block diagram of a GPS receiver having an oscillator synchronized to a cellular carrier, according to one embodiment of the present invention.

FIG. 5 is a block diagram of a GPS receiver having an oscillator synchronized to a cellular carrier, according to an alternative embodiment of the present invention.

FIG. 6 is a block diagram of an alternative to FIG. 2 in which the GPS receiver and FM receiver share a common antenna.

### DETAILED DESCRIPTION

Applicants have appreciated and discovered that the performance of devices utilizing a reference oscillator, such as but not limited to GPS receivers, may be improved by improving the stability of the reference oscillator of such devices, and furthermore have appreciated that the stability of the reference oscillator of at least some such types of devices may be stabilized by synchronizing the reference oscillator to an externally received signal. The externally received signal may be a radio signal (e.g., an FM radio signal from an FM radio tower, a cellular signal from a cellular base station, etc.), or any other externally received signal that is itself stable. Applicants have appreciated that, because atomic clock sources typically exhibit high stability, it may be beneficial to use an atomic clock signal or other signal synchronized to an atomic clock signal as the externally received signal to which the reference oscillator is synchronized.

As a non-limiting example, navigation receivers, such as GPS receivers, may be improved by improving the stability of the reference oscillator of the navigation receiver. Navigation receivers, such as GPS receivers, may include a reference oscillator which generates an oscillating reference signal used to process a received navigation signal (e.g., a received GPS signal). Applicants have appreciated that improving the stability of the oscillating reference signal, for example to minimize drift of the oscillating reference signal, may reduce errors in position readings provided by the navigation receiver, as well as improving TTFF and TTSF. Accordingly, methods and apparatus are described herein for stabilizing reference oscillators of navigation receivers as well as other devices.

According to one aspect, a method of stabilizing an oscillating reference signal generated by a reference oscillator of a device (e.g., a navigation receiver) is provided. The method comprises receiving a first wireless signal with the device and synchronizing the reference oscillator of the device to the first wireless signal such that a frequency of an oscillating reference signal generated by the reference oscillator is synchronized to a frequency of the first wireless signal. A second wireless signal different from (or distinct from) the first wireless signal is received and the second wireless signal is processed using the oscillating reference signal generated by the reference oscillator.

According to another aspect, an apparatus is provided including a reference oscillator, a first receiver and a second receiver. The reference oscillator generates an oscillating reference signal. The first receiver receives a first wireless signal and the reference oscillator is synchronized to the first wireless signal. The second receiver receives a second wireless signal different from the first wireless signal and processes the second wireless signal using the oscillating reference signal from the reference oscillator.

As used herein, synchronizing one signal to another (e.g., a first signal to a second signal, or an oscillating reference signal to an external oscillating signal) may include any of the following: (a) directly synchronizing the first signal to the second signal; (b) matching a frequency of the first signal to a frequency of a signal derived from the second signal; (c) matching a frequency of a signal derived from the first signal to a frequency of the second signal; and (d) matching a frequency of a signal derived from the first signal to a frequency of a signal derived from the second signal. For example, as will be described herein, a reference oscillator signal may be synchronized to a received wireless signal (e.g., an external oscillating signal) by matching the frequency of the reference oscillator signal to the frequency of the wireless signal. Alternatively, the reference oscillator signal may be synchronized to a signal derived from the wireless signal (e.g., by multiplying or dividing the frequency of the wireless signal using a synthesizer). Further still, the reference oscillator signal may be multiplied or divided (e.g., using a synthesizer receiving the reference oscillator signal) and the frequency of the resulting signal may then be matched to the frequency of the wireless signal or to a frequency of a signal derived from the wireless signal by multiplying or dividing the wireless signal (e.g., using a synthesizer receiving the wireless signal). Any such scenario is referred to herein as synchronizing the reference oscillator signal to the wireless signal.

For ease of illustration, various aspects will now be described in the context of GPS receivers. However, it should be appreciated that the various aspects described herein relating to stabilizing reference oscillators may apply to other devices utilizing a reference oscillator as well, such as cellular telephones, personal digital assistants (PDAs), or other wireless communication devices, among others. Thus, the following discussion in the context of GPS receivers is non-limiting.

The Global Positioning System is a space-based radio-navigation system that uses ranging signals broadcasted by multiple satellites to determine a precise position on or in proximity of the earth. Each satellite of the system continuously transmits a navigation message encoded at 50 bit/s and which contains three parts. The first part contains the GPS date and time (time-of-week and GPS week number) and the satellite's health status. The second part comprises high precision orbital information of the satellite referred to as ephemeris data. The third part contains the almanac data that contains information on coarse orbit and status of all satellites in the constellation, an ionospheric model, and the relationship of GPS derived time and Coordinated Universal Time (UTC).

Each satellite of the GPS system broadcasts signals using the two carrier frequencies 1575.42 MHz, also referred to as L1 frequency, and 1227.60 MHz, referred to as L2 frequency. Multiple frequencies are used for multiple reasons, including redundancy, resistance to jamming, and ability to measure the ionospheric delay error. A GPS system might use one, two, or more frequencies and it should be understood that the various aspects described herein applying to GPS receivers are not limited to using any particular number of frequencies.

To distinguish signals from different satellites despite the signals being sent on the same carrier frequency (e.g., the L1 carrier frequency) the GPS system uses a code division multiple access (CDMA) spread-spectrum technique. The navigation message, described above, is encoded with a 1023 bit long pseudo random (PRN) sequence that is unique for each satellite. This CDMA encoding is often referred to as coarse/acquisition code (C/A) or Gold code. The 1023 bit C/A sequence has a period of 1 millisecond and is transmitted continuously. Only 32 combinations of all possible combinations from the 1023 bit long code are used, and each satellite in the GPS system uses one unique code. Currently, only the L1 carrier is modulated with the C/A code, but additional frequencies may become available for civil applications in the future and it should be understood that the aspects described herein are not limited to GPS receivers using any specific number of carrier frequencies. In addition to C/A code, a high precision military CDMA code (so-called P code) exists, which is not described in detail here.

The following further discussion describes several aspects in the context of a GPS system using the GPS L1 frequency carrier. However, as mentioned, the various aspects are not limited to use in GPS receivers and are not limited to using the L1 frequency carrier when a GPS receiver is used. Furthermore, those aspects applicable to GPS receivers are not limited to any particular type of GPS receiver (and may include differential GPS receivers) unless otherwise stated, and are not limited in the manner of generating GPS information, the type of encoding (e.g., C/A code, P code, or any other type of coding) employed, the code length, the carrier modulation technique, or the number of satellites used. Furthermore, as has been mentioned, the various aspects described herein are not limited to GPS receivers, but may also apply to other navigation receivers, among other devices.

The 1575.42 MHz carrier frequency (L1) is generated by an atomic clock in each satellite, providing utmost stability and accuracy. Large frequency fluctuations of the carrier frequency affect the achievable accuracy of the position computed by a GPS receiver based on the satellite ranging signal, and further affect the time it takes to compute a valid position, as well as influencing the critical signal level necessary to obtain a position estimate. The use of highly precise atomic clocks in the satellites minimizes these effects.

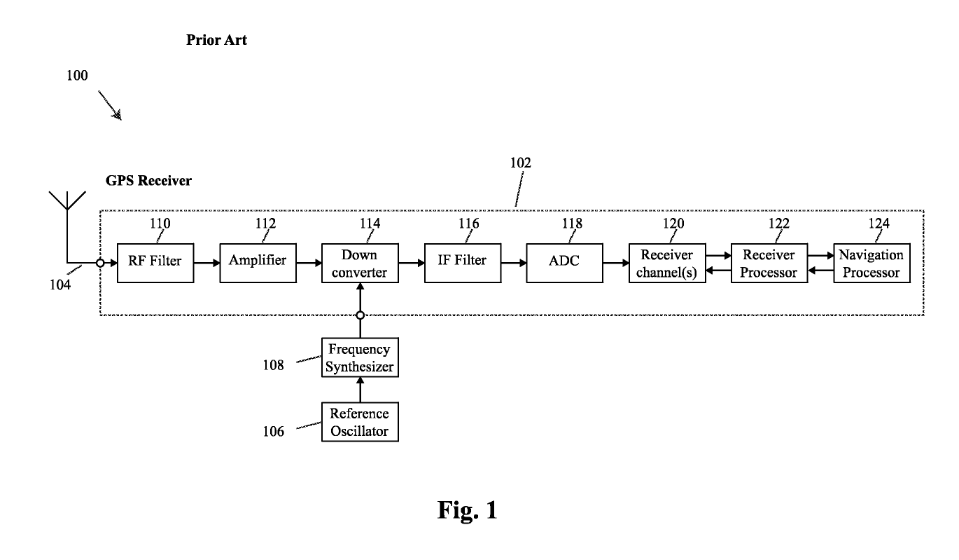

For a GPS receiver to obtain a position based on the received ranging signals of multiple satellites, the actual ranging signal has to be demodulated from the carrier. This demodulation requires a reference frequency on the receiver side to down-convert the GPS signal. A block diagram of a conventional GPS receiver 100 is shown in FIG. 1. The antenna 104 will receive the GPS signals of all satellites available. The received signals are then filtered by a radiofrequency (RF) filter 110 and amplified by an amplifier 112. The amplified signals are then down-converted to an intermediate frequency of typically 1-20 MHz in down-converter 114. The down-conversion process requires a reference frequency which is generated by a frequency synthesizer 108 based on a reference oscillator 106. The intermediate frequency (IF) signals produced by down-converter 114 are then filtered in an IF filter 116 and converted to digital IF signals in an analog-to-digital converter (ADC) 118. The digital IF signals are then processed in one or more receiver channels 120. Each receiver channel includes two tracking loops, one for tracking the GPS carrier (a “carrier frequency tracking loop”) and one for tracking the GPS code (a “code tracking loop”) of a particular satellite. Advanced systems possess multiple receiver channels and therefore can track multiple satellites at the same time. Less sophisticated GPS units use multiplexing of multiple satellites and lock to one satellite at a time.

The carrier frequency tracking loop of a receiver channel 120 uses a phase locked loop (PLL) to lock a numerically controlled oscillator (NCO) to the digital IF signals from ADC 118 for a particular satellite, or rather to the satellite's C/A code. The frequency tracked by the PLL (f_{PLL}) incorporates any frequency variation of the satellite carrier due to Doppler shifts, fluctuations of the satellite's time base, frequency inaccuracies and drift of the local reference oscillator 106 introduced during the down-conversion by down-converter 114 and the analog-to-digital sampling process of ADC 118.

The code tracking loop of receiver channel 120 uses a delay-lock loop (DLL) to track the C/A code of the respective satellite for each receiver channel. The DLL uses the carrier replica signal from the NCO of the carrier frequency tracking loop. Tracking the delay of the C/A code in the DLL yields information about the time delay between the satellite and the receiver, basically by measuring the offset between the received PRN sequence and the internally generated 1023 bit C/A code replica. In combination with knowledge of the precise satellite time and position, the range of the GPS receiver from the satellite can be estimated. As the PRN code is transmitted over a period of 1 ms, one bit corresponds to 0.98 microseconds (10⁻³ s/1023), which, assuming the propagation of the satellite signal at the speed of light (299 792 458 m/s), corresponds to a distance of 293 meters. Currently available GPS receivers are able to detect the offset of rising and trailing edges of each bit to about 1% accuracy, which reduces the location uncertainty of 293 meters to less than 3 meters. The ranges for the satellite determined from the code tracking loop are referred to as pseudoranges. The expression of pseudorange refers to the range estimates being affected by a common offset. The delay obtained from the DLL tracking is affected by the clock error of the reference (or “local”) oscillator. Because the clock error is assumed to be constant over a short period of time, the error of the range estimates is assumed to be constant.

The receiver processor 122 in FIG. 1 handles the control loops for both the GPS carrier frequency tracking and the GPS code tracking. The navigation processor 124 uses the pseudorange estimates, described above, to solve for the unknowns of the position x, y, and z, and the clock timing error Δτ. Since there are four unknowns (x, y, z, Δτ), in general the GPS receiver will require at least the pseudoranges of four satellites to solve for the unknowns. By solving for the four unknowns, the receiver position can be established.

The accuracy of the frequency f_{PLL} tracked by the GPS carrier frequency tracking loop is affected by the GPS carrier-to-noise (C/N) ratio (white noise phase jitter), satellite clock phase jitter, receiver clock phase jitter, vibration-induced phase jitter, atmospheric phase jitter (all colored noise phase jitter), and dynamic stress due to sudden movement of the receiver. Depending on the application, the receiver clock phase jitter may be one of the most dominating effects.

The accuracy and stability of the frequency f_{PLL} determines the accuracy of the resulting calculated position of the GPS receiver and the robustness of the GPS receiver operation for very low C/N ratios. Robustness against cycle slip of the carrier tracking loop may impact performance of the GPS receiver, for example influencing the ability of the GPS receiver to maintain lock on the GPS carrier. Cycle slip can occur for numerous reasons including weak GPS signal strength (for example as may occur inside buildings, caves, and obstructions), strong phase fluctuations of the GPS signal (for example as may result from ionospheric fluctuations/scintillation effects, multi-path reflections in urban environment, etc.), dynamic stress, or any instability or malfunction of the satellite or receiver.

As mentioned previously, the GPS satellites use atomic clocks with excellent stability, very low phase jitter and very high accuracy. The accuracy of the atomic clock can be adjusted in the satellite and correction information is provided to the GPS receiver as part of the navigation message transmitted by the satellite. However, the price, weight, power consumption and availability of atomic clocks forbid the practical use of atomic clocks as reference oscillators in consumer electronics. In practice, GPS receivers use temperature compensated crystal oscillators (TCXOs) or, for higher performance, oven controlled crystal oscillators (OCXOs) as the reference oscillator (e.g., as reference oscillator 106 in FIG. 1) instead of atomic clocks. Compared to atomic clocks, TCXOs and OCXOs are relatively inexpensive, miniature in size, and possess light weight.

In general, the stability, phase jitter and frequency accuracy of TCXOs and OCXOs is inferior to that of atomic clocks. In general, the phase jitter of the GPS receiver clock is two orders of magnitude worse than the satellite carrier's phase jitter. As a result, the phase jitter of the reference clock may strongly influence the GPS signal strength required for the GPS receiver to maintain lock. The phase jitter of the reference clock may also limit the obtainable position accuracy and the time to fix the position. In the event of a GPS signal outage, the stability of the reference clock may be of heightened importance. The Allan deviation is often used to estimate the stability of the reference clock and to establish for what periods of GPS outages the receiver is able to re-establish a lock with the carrier signal without suffering a cycle slip.

In general, the more stable, accurate and low noise the reference frequency provided by the reference oscillator of a GPS receiver, the more precise the predicted GPS receiver position will be. At the same time, a more accurate reference frequency will enable the GPS receiver to lock faster to the received GPS signal. The faster locking is established, the faster the current position can be established, also referred to as “Time to fix”, i.e. the time it takes the GPS unit to estimate the position (fix the position). The time to fix is determined by a variety of factors and is technically divided into several categories and referred to as “Time to First Fix” (TTFF) for a “Cold”, “Warm” and “Hot” GPS unit.

A “Cold” GPS unit lacks valid almanac data. The almanac data contains approximate information on the position of the GPS satellites. To obtain the almanac data the GPS unit systematically searches for a GPS satellite signal and starts to receive the almanac data, that is transmitted repeatedly over 12.5 minutes and is part of the navigation message. Based on this information, the GPS unit knows the status and approximate location of the other satellites in the system. The TTFF for a cold GPS unit is therefore at least 12.5 minutes. However, the almanac data remains valid for at least 180 days.

A “Warm” GPS unit has valid almanac data and rough knowledge of the current time and location. Based on the time and almanac data the GPS unit possesses a rough estimate of the satellite positions in the system. It still has to receive the precise location data, referred to as ephemeris data, of each satellite that is going to be used in the computation of the position. The ephemeris data is broadcasted every 30 seconds and remains valid for up to 4 hours.

A “Hot” GPS has the valid time, position, almanac and ephemeris data of used satellites and only requires a reading of their PRN ranging signals. The time it takes to fix the position for this scenario is referred to as “Time to subsequent fix” (TTSF).

The reception of weak GPS signals and the ability of the GPS receiver to, nevertheless, obtain and maintain lock to the GPS signals affects the TTFF as well as the position accuracy. Any difficulties of locking will affect the time to download the almanac data, ephemeris data and the PRN ranging signals.

Assuming the GPS receiver to possess valid almanac and ephemeris data, the TTSF is affected by any delay in acquiring valid PRN ranging signals as well as the GPS receiver's ability to work under weak signal conditions.

According to one aspect, a method for stabilizing a reference oscillator of a GPS receiver is provided, involving synchronizing (or “locking”) the reference oscillator to a stable external signal, such as but not limited to a cellular carrier signal, an FM radio station signal, a television (TV) station signal, or any other radio signal that is available and exhibits a desired degree of stability. Such a method may improve the stability of the reference oscillator and thus allow for use of reference oscillators which are relatively inexpensive, imprecise, and unstable compared to atomic clocks Signals which are controlled by or synchronized to an atomic clock (e.g., FM radio station signals) may be used as the external signals to which the reference oscillator is synchronized in some embodiments, since use of such signals may result in the reference oscillator exhibiting stability comparable to, or substantially the same as, that of an atomic clock.

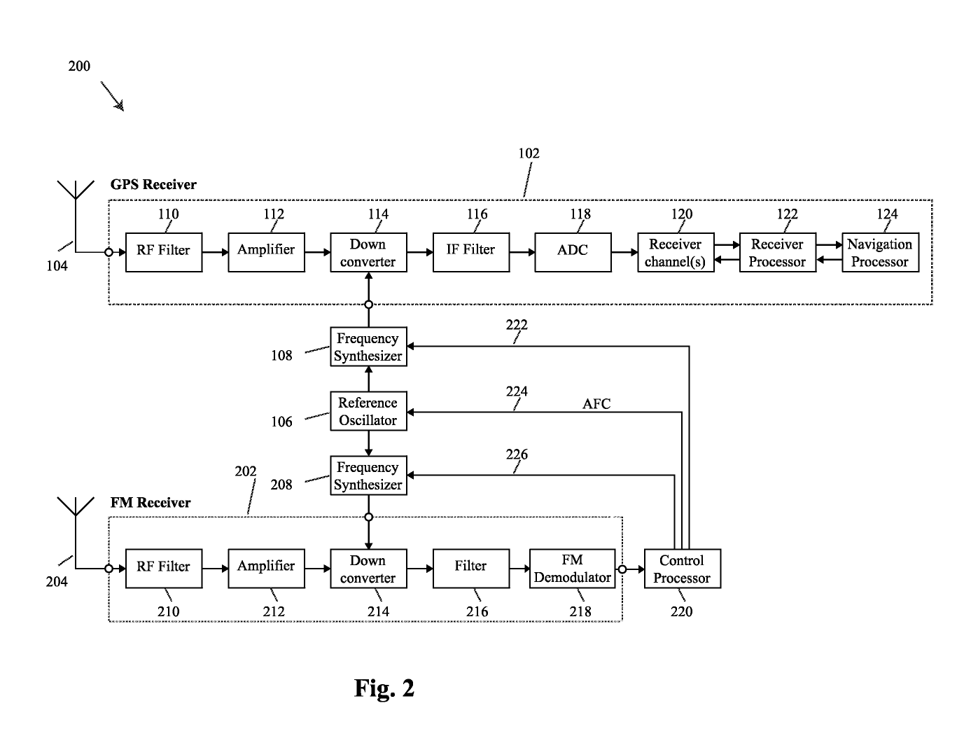

According to a first non-limiting aspect, the reference oscillator of a GPS receiver is synchronized to an external FM radio signal, for example provided by an FM radio station. The FM radio signal may be received by the GPS receiver in any suitable manner and the synchronization of the reference oscillator to the FM radio signal may be performed in any suitable manner. As a non-limiting example, the GPS receiver may be a combined GPS receiver/FM receiver configured to receive both GPS signals from GPS satellites as well as an FM radio signal. FIG. 2 illustrates a non-limiting example.

FIG. 2 is a block diagram of an apparatus 200 having a GPS receiver 102 integrated with a FM receiver 202, according to one non-limiting embodiment. It should be understood that numerous other configurations are possible, and that the shown configuration is merely an example. The GPS receiver 102 is identical to the GPS receiver of FIG. 1. In FIG. 2, the reference oscillator 106 also provides a reference frequency for the FM receiver 202 and is controlled by a tuning signal 224.

The FM receiver 202 is tuned to a given radio station by the control processor 220 and the frequency synthesizer 208 is adjusted to the frequency of that radio station via the control signal 226 provided to the frequency synthesizer by the control processor 220. It should be understood that this is one possible example and that the illustrated architecture of the FM receiver represents only one possible embodiment.

An FM signal is received by the antenna 204, filtered by RF filter 210, amplified by amplifier 212, down-converted by down-converter 214 using the synthesized frequency from frequency synthesizer 208, and filtered by a filter 216. Demodulation of the FM signal using FM demodulator 218 results in an output signal being provided to the control processor 220 to determine the frequency difference between the FM carrier signal and the reference frequency of reference oscillator 106. As a result, the control processor 220 can adjust the reference oscillator 106 with the control tuning signal 224 to synchronize the FM signal (e.g., the carrier of the FM signal) and the reference frequency. The tuning feedback represented by tuning signal 224 may be performed similarly to known automatic frequency control (AFC) tuning techniques for communications devices.

Operating the FM receiver 202 in the manner described above allows for synchronizing (“locking”) the reference oscillator to the carrier of an FM radio station. In many instances, the carrier signals provided by FM radio stations are controlled or linked to an atomic clock. Thus, by synchronizing the reference oscillator of a GPS device (e.g., reference oscillator 106 in FIG. 2) to an FM signal in the manner described with respect to FIG. 2, the stability and accuracy of the reference oscillator 106 may be similar to or substantially the same as that of an atomic clock, and thus may represent an improvement compared to conventional references oscillators of conventional GPS receivers. It should be understood that tuning to the FM carrier frequency represents one possible embodiment and that the synchronizing/locking of the reference oscillator to a FM signal may alternatively involve synchronizing/locking to the subcarrier, pilot tone or any other highly accurate frequency information contained in the FM signal.

Referring still to FIG. 2, the frequency synthesizer 108 receives the output signal of the reference oscillator 106 and provides a reference signal for the GPS receiver 102 which, as described previously with respect to FIG. 1, is used in down-converting a GPS signal received by GPS receiver 102. Because the output signal of the reference oscillator 106 may be made highly stable using the techniques described herein of synchronizing the reference oscillator to an FM signal, the signal produced by frequency synthesizer 108 may also be highly stable. In some cases the control processor may provide a control signal 222 to adjust the frequency synthesizer 108. Because of the improved accuracy and stability of the reference frequency provided by the reference oscillator and therefore provided by the frequency synthesizer 108, the GPS receiver 102 may obtain a more precise position, operate under lower C/N ratio, and better handle GPS signal outages than conventional systems.

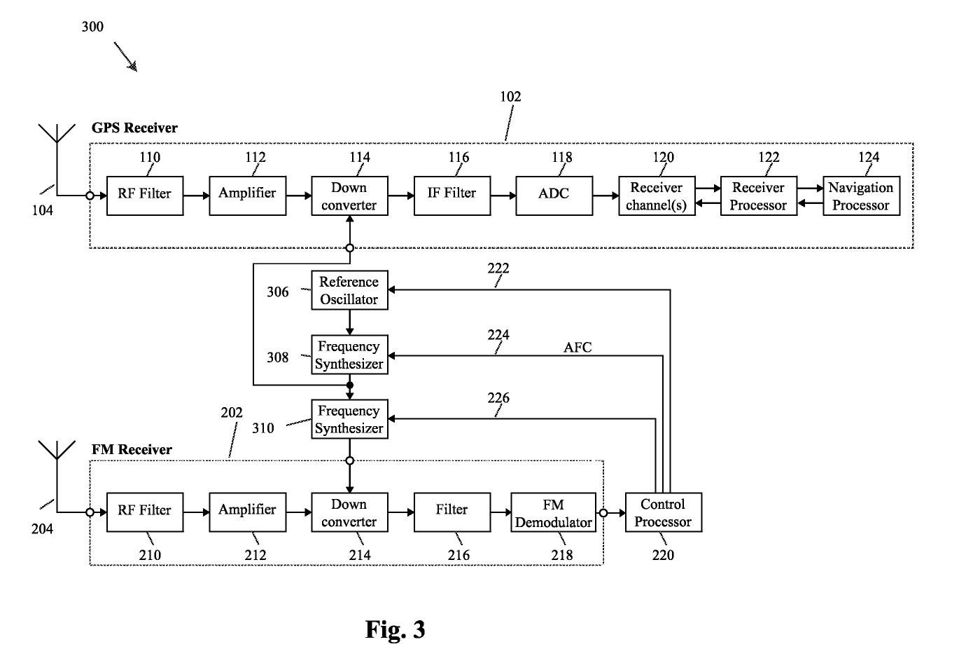

A modification of the integrated GPS receiver with an FM receiver is shown in FIG. 3 as apparatus 300, representing an alternative configuration in which the reference oscillator of the GPS receiver may be synchronized to a received FM signal. The GPS receiver 102 and the FM receiver 202 are substantially the same as previously described with respect to FIG. 2 and thus are not described in detail here. However, the apparatus 300 differs from the apparatus 300 in terms of the configuration and operation of the reference oscillator and frequency synthesizers of the apparatus.

In FIG. 3, the reference oscillator 306, which may be the same type of oscillator as oscillator 106 of FIG. 2, provides a reference signal to the first frequency synthesizer 308, which is connected to a second frequency synthesizer 310. The output of the first synthesizer 308 represents the RF reference frequency used by the GPS receiver 102. The second frequency synthesizer 310 then converts the output of frequency synthesizer 308 (the GPS reference frequency) to a frequency close to a FM radio signal. The control processor 220 adjusts the reference oscillator 306 to obtain synchronization/lock to the FM carrier signal received by FM receiver 202. Assuming the FM carrier signal is itself stable (e.g., if the FM carrier signal is synchronized to an atomic clock), the reference signal provided to the GPS receiver in FIG. 3 may be very stable and accurate, which may allow the GPS receiver to operate despite weak signal conditions and signal outages, and may allow the GPS receiver to obtain improved position accuracy.

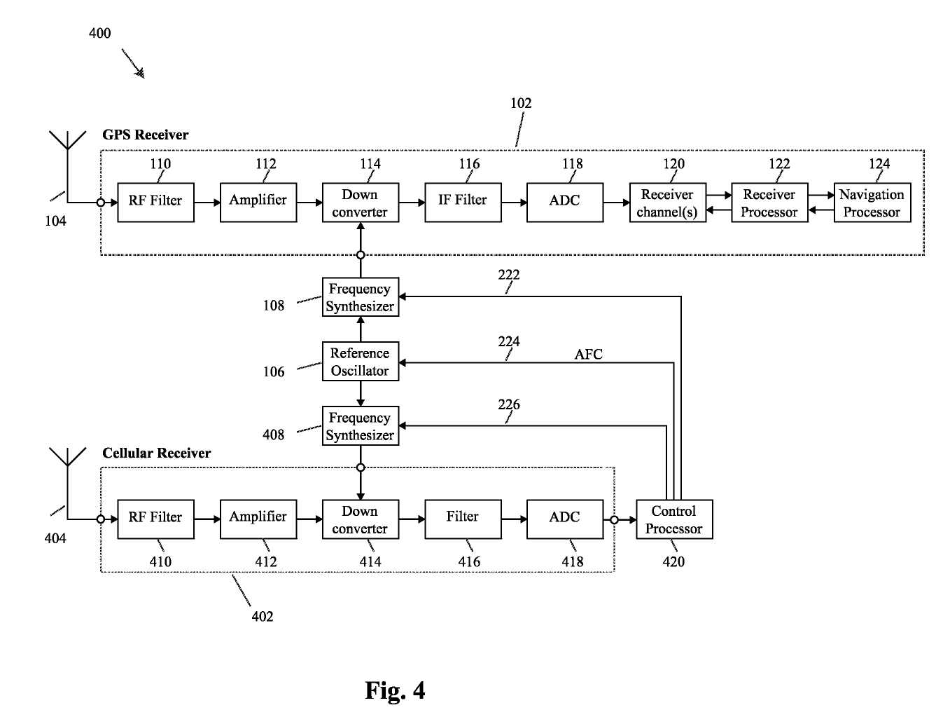

According to another non-limiting aspect, the reference oscillator of a GPS receiver is synchronized to an external cellular signal, for example provided by a cellular telephone base station. The cellular signal may be received by the GPS receiver in any suitable manner and the synchronization of the reference oscillator to the cellular signal may be performed in any suitable manner. As a non-limiting example, the GPS receiver may be a combined GPS receiver/cellular receiver configured to receive both GPS signals from GPS satellites as well as cellular network signals. FIG. 4 illustrates a non-limiting example.

FIG. 4 illustrates a block diagram of an apparatus 400 having a GPS receiver 102 integrated with a cellular receiver 402. It should be understood that numerous other configurations are possible and that the configuration illustrated is merely a non-limiting example. The GPS receiver is identical to the GPS receiver of FIG. 1. The apparatus 400 is similar to the apparatus 200 of FIG. 2 except that in FIG. 4 the reference oscillator 106 provides a reference frequency for the cellular receiver 402 instead of the FM receiver of FIG. 2.

The cellular receiver 402 is tuned to a given cellular signal by the control processor 420 and the output signal of the frequency synthesizer 408 is adjusted to the frequency of that cellular signal via the control signal 226. The reference oscillator 106 is provided the tuning signal 224 as described above in connection with FIG. 2. It should be understood that this is one possible example and that the architecture of the cellular receiver represents only one possible embodiment.

The cellular signal is received by the antenna 404, filtered by RF filter 410, amplified by amplifier 412, down-converted by down-converter 414 using the synthesized frequency from 408, and then filtered by a filter 416. Analog-to-digital conversion of the baseband cellular signal using ADC 418 results in an output being provided to the control processor 420 to determine the frequency difference between the cellular carrier signal and the reference frequency provided by frequency synthesizer 408. As a result, the control processor 420 can adjust the reference oscillator 106 with the control tuning signal 224. Using this method, the reference oscillator may be synchronized (locked) to the carrier of a cellular signal. In many instances, the carrier of the cellular signal may be controlled or linked to an atomic clock, thus making it highly stable. As a result, the stability and accuracy of the reference oscillator 106 may be improved over those of oscillators in conventional navigation receivers and may be similar to or substantially the same as those of an atomic clock.

Referring still to FIG. 4, the frequency synthesizer 108 receives the output signal of the reference oscillator 106 and provides a reference signal for the GPS receiver 102. In some cases the control processor may optionally produce a control signal 222 to adjust the frequency synthesizer 108. Because of the improved accuracy and stability of the reference frequency provided by the reference oscillator and the frequency synthesizer 108, the GPS receiver 102 may obtain a more precise position, operate under lower C/N ratio, and better handle GPS signal outages than conventional systems.

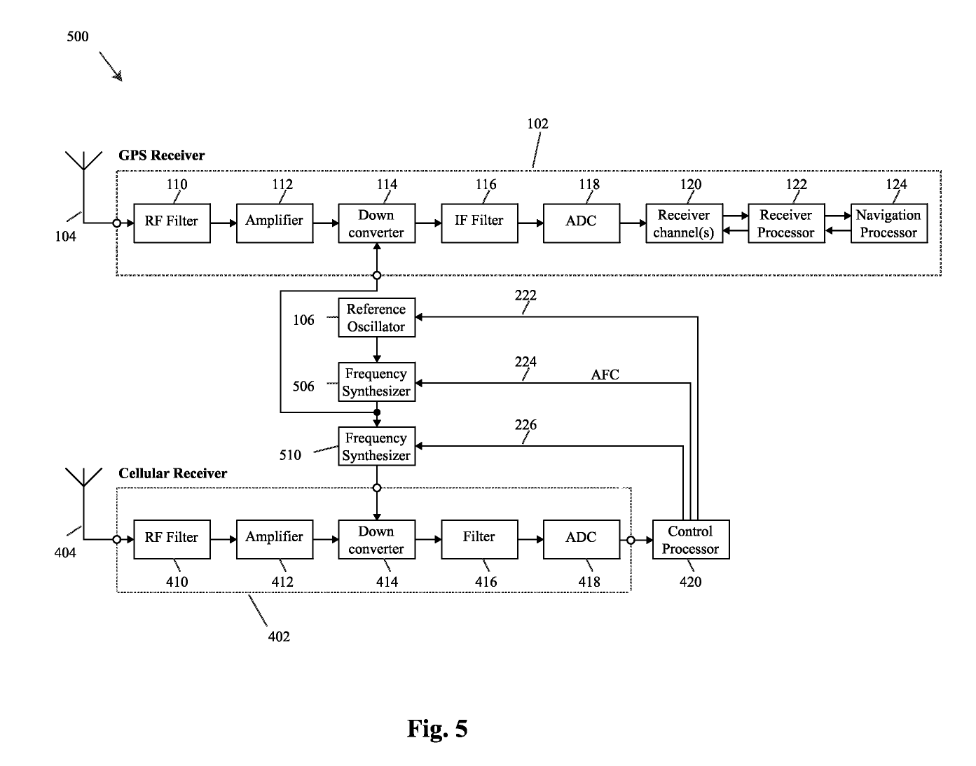

A modification of the integrated GPS receiver with a cellular receiver is shown in FIG. 5 as apparatus 500, representing an alternative configuration in which the reference oscillator of the GPS receiver may be synchronized to a cellular signal. The GPS receiver 102 and the cellular receiver 402 are substantially the same as previously described with respect to FIG. 4 and thus are not described in detail here. However, the apparatus 500 differs from the apparatus 400 in terms of the configuration and operation of the reference oscillator and frequency synthesizers of the apparatus.

In this case, the reference oscillator 106 provides an oscillating reference signal to the first frequency synthesizer 506, which in turns provides a signal to a second frequency synthesizer 510. In this case the output of the first synthesizer 506 represents the RF reference frequency required by the GPS receiver 102. The second frequency synthesizer 510 then converts the output of the frequency synthesizer 506 (the GPS reference frequency) to a frequency close to a cellular radio signal. The control processor 420 adjusts the reference oscillator 106 to obtain synchronization/lock to the cellular carrier signal. As a result, the reference signal provided to the GPS receiver may be very stable and accurate, which may allow the GPS receiver to operate under weak signal conditions and signal outages, and to obtain improved position accuracy.

It should be appreciated from the foregoing non-limiting examples of FIGS. 2-5 that according to one aspect an apparatus comprising multiple receivers is provided. One of the receivers may be used to receive a wireless signal upon which the apparatus is to operate. The apparatus may include a reference oscillator configured to generate an oscillating reference signal (which may be referred to as an “internal oscillating signal” or “internal reference signal”) which may be used to process the wireless signal received by the first receiver. A second receiver of the multiple receivers may receive a second wireless signal. The apparatus may be configured to synchronize the reference oscillator to the second wireless signal such that a frequency of the oscillating reference signal is synchronized to the second wireless signal. In some embodiments, the apparatus may include a processor configured to at least partially control the synchronization of the reference oscillator to the second wireless signal. The apparatus may be a navigation receiver (e.g., a GPS receiver), a space-based radio-navigation receiver, or any other suitable apparatus.

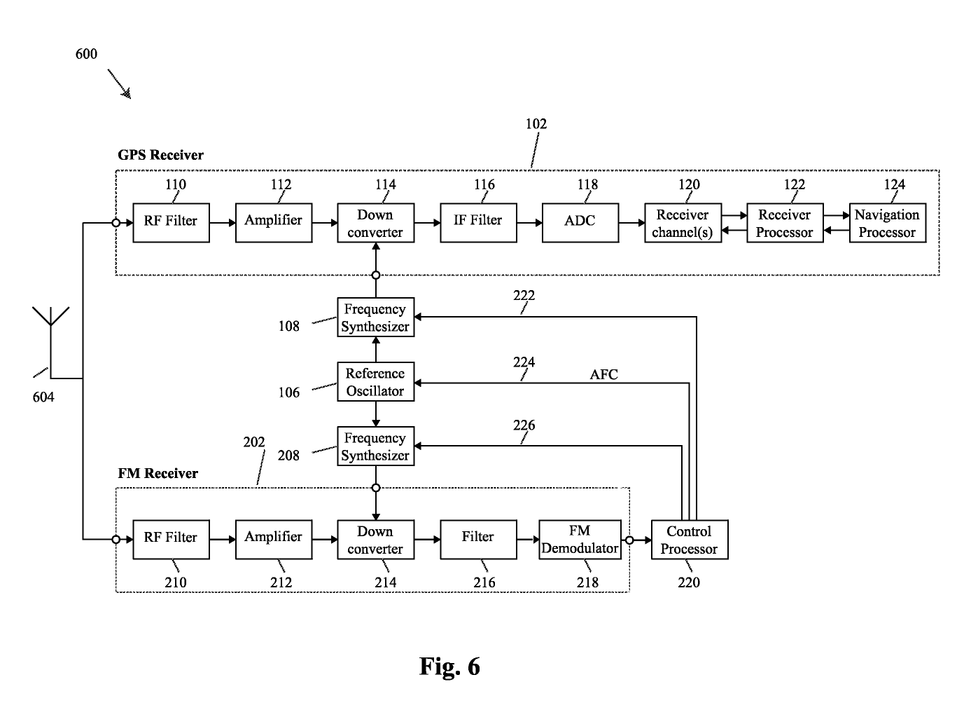

It should further be appreciated that the configurations of components illustrated in FIGS. 2-5 are non-limiting and that various alternatives are possible and within the scope of the aspects described herein. For example, the apparatus of FIGS. 2-5 in which multiple receivers are shown each being associated with a respective antenna may be modified so that two or more receivers share an antenna. A non-limiting example is illustrated in FIG. 6.

FIG. 6 illustrates an apparatus 600 representing a variation of FIG. 2 in which the GPS receiver 102 and the FM receiver 202 share an antenna (e.g., a dual-mode antenna or multi-mode antenna) for receiving signals. As shown, antenna 604 may be common to both the GPS receiver and the FM receiver. Signals received on the antenna 604 may be provided to the correct one of receivers 102 and 202 in any suitable manner. According to some embodiments, the RF filters 110 and 210 may be set to pass only the desired type of signal for the corresponding receiver 102 or 202. Such operation of the filters 110 and 210 may be facilitated by the use of signals of significantly different frequencies, though not all embodiments are limited in this respect. For example, if the FM receiver is intended to receive wireless signals of a significantly different frequency (e.g., 60 kHz as a non-limiting example) than the frequency of GPS signals intended to be received by the GPS receiver 102 (e.g., the L1 carrier frequency as a non-limiting example), then the passbands of filters 110 and 210 may more easily be set to allow through only the desired type of signals. In view of this, it may be preferable to configure the two receivers of an apparatus (e.g., receivers 102 and 202) to operate on signals of easily distinguishable frequencies if a common antenna is to be used. For example, according to some embodiments the frequencies may differ by at least 1% from each other, by at least 10% from each other, by at least 25% from each other, or by any other suitable amount. For example, in cell phones it may be preferable for the frequencies to differ by at least 25% from each other (e.g., by between 25%-50%). In some embodiments, the frequencies may differ by at least 100 kHz, 1 MHz, 100 MHz, or any other suitable value. However, the use of filters 110 and 210 to differentiate signals received on a common antenna is not limited to situations in which the receivers 102 and 202 operate on signals having any particular frequency difference.

It should be appreciated that a common antenna configuration like that shown in FIG. 6 may apply equally well to the embodiments of FIGS. 3-5 or any of the aspects described herein in which multiple signals are received.

The reference oscillators according to the various aspects described herein may be any suitable type of reference oscillators. For example, as mentioned, the oscillators may be conventional quartz crystal oscillators, OXCOs, TCXOs, MEMS oscillators, or any other suitable type of oscillators. As mentioned previously, use of one or more of the aspects described herein may enable the use of relatively imprecise and/or unstable reference oscillators since the stability may be made substantially equal to that of the external wireless signal to which the reference oscillator is synchronized. According to one embodiment, the reference oscillator may be frequency tunable. For example, the reference oscillator may be of a type described in U.S. Patent Publication 2010-0308927-A1, published on Dec. 9, 2010 and incorporated herein by reference in its entirety.

The various examples described thus far of wireless signals received by an apparatus and used for synchronizing the reference oscillator of an apparatus are non-limiting. Thus, it should be understood that the use of locking a reference oscillator directly or indirectly to a FM or cellular signal represents only two possible embodiments. Any available radio signal with better frequency stability and accuracy than the reference oscillator of the apparatus (e.g., of a GPS receiver) may be used. Furthermore, any suitable component of a received signal may be used for performing the synchronization. For example, the reference oscillator may be synchronized to a carrier of a received wireless signal (e.g., to a carrier signal), to a sub-carrier of a received wireless signal, to a pilot tone, to a combination of carrier and sub-carrier of radio signals, to a combination of two or more radio signals, or to any other suitable radio signal or component of a received wireless signal. It should be appreciated that in at least some embodiments the signal to which the reference oscillator is synchronized may be of a different type than that upon which the apparatus (e.g., GPS receiver) operates. For example, one signal may be a GPS signal while the other may be a FM signal or cellular signal.

The various aspects described herein are not limited to use with signals of any particular frequencies. For example, the reference oscillators described herein may be used to produce oscillating reference signals having frequencies in a range of approximately 120 MHz centered around 1575.42 MHz, or alternatively within a range of approximately 30 MHz centered around 1575.42 MHz, though other frequencies are also possible. The frequency of the signal to which the reference oscillator is synchronized may likewise take any suitable value. For example, the signal to which the reference oscillator is synchronized may be between approximately 1 MHz and 10 GHz, and the reference oscillating signal may have a frequency in the range from 150 MHz to 1650 MHz. The signal to which the reference oscillator is synchronized may be between approximately 50 MHz and 3 GHz, and the reference oscillating signal may have a frequency in the range from 1500 MHz to 1650 MHz. The signal to which the reference oscillator is synchronized may be between approximately 100 MHz and 2 GHz, and the reference oscillating signal may have a frequency in the range from 1500 MHz to 1650 MHz. Other frequency values are also possible, as those listed represent non-limiting examples.

In some embodiments, the signal to which the reference oscillator is synchronized may have a frequency of 40 kHz, 60 kHz, 66.66 kHz, 75 kHz, 77.5 kHz, 162 kHz, 198 kHz, 2.5 MHz, 3.33 MHz, 5 MHz, 7.85 MHz, 10 MHz, 15 MHz, or 20 MHz. In some embodiments in which a navigation receiver receives a navigation signal used to determine location, the navigation signal has a frequency in the range of: 1500 MHz to 1650 MHz; 1164 MHz to 1214 MHz or within 120 MHz of this range; 1563 MHz to 1591 MHz or within 120 MHz of this range; 1260 MHz to 1300 MHz or within 120 MHz of this range; 406.0 MHz to 406.1 MHz or within 30 MHz of this range. Other frequency values are also possible as these are non-limiting examples.

Furthermore, according to some embodiments, a specific infrastructure may be constructed to support operation of devices according to the various aspects described herein. For example, specific beacons or radio signals with very high frequency stability and accuracy may be deployed either locally or globally to provide a wireless signal to which the reference oscillator of a navigation device or other device may be synchronized. In this manner, the operation of navigation devices (e.g., GPS receivers) may exhibit higher accuracy than conventional devices and such devices may operate at very low GPS signal levels and during GPS signal outages.

Having thus described several aspects of at least one embodiment of the technology, it is to be appreciated that various alterations, modifications, and improvements will readily occur to those skilled in the art. Such alterations, modifications, and improvements are intended to be within the spirit and scope of the technology. Accordingly, the foregoing description and drawings provide non-limiting examples only.

What is claimed is:

1. An apparatus, comprising:
a reference oscillator configured to generate an oscillating reference signal;
a first receiver configured to receive a first wireless signal, wherein the reference oscillator and the first receiver are coupled together and configured to synchronize the oscillating reference signal to the first wireless signal such that a frequency of the oscillating reference is synchronized to a frequency of the first wireless signal;
a second receiver configured to receive a second wireless signal different from the first wireless signal, wherein the second receiver is configured to process the second wireless signal using the oscillating reference signal.

2. The apparatus of claim 1, wherein the first receiver is a frequency modulation (FM) receiver or a cellular receiver and the first wireless signal is a FM radio signal or a cellular radio signal, and wherein the second receiver is a global positioning system (GPS) receiver and the second wireless signal is a GPS navigation signal.

3. The apparatus of claim 1, wherein the reference oscillator is frequency tunable.

4. The apparatus of claim 1, wherein the reference oscillator and first receiver are coupled in a tracking loop configured to synchronize the oscillating reference signal to the first wireless signal.

5. The apparatus of claim 4, wherein the tracking loop comprises a processor configured to provide a tuning signal to the reference oscillator to adjust a frequency of the oscillating reference signal.

6. The apparatus of claim 5, wherein the processor is configured to receive an indication of whether the oscillating reference signal and the first wireless signal are synchronized and wherein the processor provides the tuning signal in response to the oscillating reference signal and external oscillating signal not being synchronized.

7. The apparatus of claim 1, further comprising a first antenna coupled to the first receiver and configured to receive the first wireless signal, and further comprising a second antenna coupled to the second receiver and configured to receive the second wireless signal.

8. The apparatus of claim 1, wherein the first receiver is a frequency modulation (FM) receiver.

9. The apparatus of claim 1, wherein the first receiver is a cellular receiver.

10. The apparatus of claim 1, wherein the second receiver is a global positioning system (GPS) receiver.

11. The apparatus of claim 1, wherein the first wireless signal is synchronized to an atomic clock.

12. The apparatus of claim 1, further comprising an antenna coupled to the first receiver and the second receiver, and wherein the first receiver is configured to receive the first wireless signal via the antenna and the second receiver is configured to receive the second wireless signal via the antenna.

13. The apparatus of claim 1, wherein the first receiver is configured to receive the first wireless signal via a first antenna and the second receiver is configured to receive the second wireless signal via a second antenna.

14. A method, comprising:
receiving a first wireless signal with a device;
synchronizing a reference oscillator of the device to the first wireless signal such that a frequency of a oscillating reference signal produced by the reference oscillator is synchronized to a frequency of the first wireless signal;
receiving a second wireless signal different from the first wireless signal with the device; and
processing the second wireless signal using the oscillating reference signal.

15. The method of claim 14, wherein the first wireless signal is a frequency modulation (FM) radio signal.

16. The method of claim 14, wherein the first wireless signal is a cellular radio signal.

17. The method of claim 14, wherein the second wireless signal is a global positioning system (GPS) signal.

18. The method of claim 17, wherein the first wireless signal is a frequency modulation (FM) radio signal or a cellular radio signal.

19. The method of claim 14, wherein processing the second wireless signal using the oscillating reference signal comprises down-converting the second wireless signal using the oscillating reference signal.

20. The method of claim 14, wherein the device is a global positioning system (GPS) receiver,
wherein receiving a first wireless signal with the device comprises receiving a frequency modulation (FM) radio signal or a cellular radio signal, and
wherein receiving a second wireless signal with the device comprises receiving a GPS signal.

21. The method of claim 20, wherein the GPS receiver comprises a first antenna and a second antenna, wherein receiving the first wireless signal comprises receiving the first wireless signal using the first antenna, and wherein receiving the second wireless signal comprises receiving the second wireless signal using the second antenna.

22. The method of claim 14, wherein synchronizing a reference oscillator of the device to the first wireless signal comprises synchronizing the reference oscillator of the device to a carrier signal of the first wireless signal.

23. The method of claim 14, wherein the first wireless signal is synchronized to an atomic clock.

24. The method of claim 14, wherein the first wireless signal is of a first type and wherein the second wireless signal is of a second type.

25. The method of claim 14, wherein synchronizing a reference oscillator of the device to the first wireless signal comprises forming a tracking loop for which the oscillating reference signal and the first wireless signal are inputs.

26. The method of claim 14, wherein receiving the first wireless signal and receiving the second wireless signal comprises receiving the first and second wireless signals on a same antenna.

27. A method of stabilizing an oscillating reference signal generated by a reference oscillator of a navigation receiver configured to receive a navigation signal, the method comprising:
receiving an external oscillating carrier signal different from the navigation signal; and
synchronizing the oscillating reference signal to the external oscillating carrier signal.

28. The method of claim 27, wherein synchronizing the oscillating reference signal to the external oscillating carrier signal comprises comparing a frequency of the oscillating reference signal to a frequency of the external oscillating carrier signal and tuning the reference oscillator to make the frequency of the oscillating reference signal equal to the frequency of the external oscillating carrier signal.

29. The method of claim 27, wherein synchronizing the oscillating reference signal to the external oscillating carrier signal comprises comparing a signal derived from the oscillating reference signal to a signal derived from the external carrier oscillating signal.

30. The method of claim 27, wherein the navigation receiver includes a first antenna for receiving the navigation signal, and wherein receiving the external oscillating carrier signal comprises receiving the external oscillating carrier signal on a second antenna of the navigation receiver.

31. The method of claim 27, wherein the external oscillating carrier signal is at least part of a frequency modulation (FM) radio signal.

32. The method of claim 27, wherein the external oscillating carrier signal is at least part of a cellular radio signal.

33. The method of claim 27, wherein the external oscillating carrier signal is a sub-carrier of a radio signal.

34. The method of claim 27, wherein the external oscillating carrier signal is synchronized to an atomic clock.

35. The method of claim 27, wherein synchronizing the oscillating reference signal to the external oscillating carrier signal comprises forming a tracking loop for which the oscillating reference signal and external oscillating signal are inputs.

36. A navigation receiver, comprising:
a reference oscillator configured to generate an internal oscillating reference signal;
a global positioning system (GPS) receiver configured to receive a GPS signal and the internal oscillating reference signal and process the GPS signal to determine a GPS location; and
a secondary receiver configured to receive an external oscillating signal different than the GPS signal,
wherein the reference oscillator is coupled to the secondary receiver.

37. The navigation receiver of claim 36, wherein the reference oscillator and secondary receiver are coupled in a tracking loop configured to synchronize the internal oscillating signal to the external oscillating signal.

38. The navigation receiver of claim 37, wherein the tracking loop comprises a processor configured to provide a tuning signal to the reference oscillator to adjust a frequency of the internal oscillating reference signal.

39. The navigation receiver of claim 38, wherein the processor is configured to receive an indication of whether the internal oscillating signal and the external oscillating signal are synchronized and wherein the processor provides the tuning signal in response to the internal oscillating signal and external oscillating signal not being synchronized.

40. The navigation receiver of claim 36, further comprising a first antenna coupled to the GPS receiver and configured to receive and provide the GPS receiver with the GPS signal, and further comprising a second antenna coupled to the secondary receiver and configured to receive and provide the secondary receiver with the external oscillating signal.

41. The navigation receiver of claim 36, wherein the external oscillating signal is a radio signal.

42. The navigation receiver of claim 36, wherein the external oscillating signal is a frequency modulation (FM) radio signal.

43. The navigation receiver of claim 36, wherein the external oscillating signal is a cellular radio signal.

44. The navigation receiver of claim 36, wherein the external oscillating signal is synchronized to an atomic clock.
